(19) United States
(12) Patent Application Publication
(10) Pub. No.: US 2006/0147000 A1
(43) Pub. Date: Jul. 6, 2006

(54) Method for in-band entity authentication via telephone

(75) Inventor: Matthew T. Novi, Jersey Village, TX (US)

Correspondence Address: OSHA LIANG L.L.P., 1221 MCKINNEY STREET, SUITE 2800, HOUSTON, TX, 77010, US

(73) Assignee: SCHLUMBERGER OMNES, INC., Houston, TX (US)

(21) Appl. No.: 11/021,884

(22) Filed: Dec. 22, 2004

(51) Int. Cl. H04M 1/64

(52) U.S. Cl. 379/88.19

(57) ABSTRACT

A method of authentication signaling on a telephone system includes preparing an authentication signal to be sent over the telephone system, sending the authentication signal over the telephone system from a first location to a second location, authenticating a user identity using stored authentication information upon receipt of the authentication signal at the second location, creating an authentication response signal to the authentication signal using a result of authenticating the user identity, and sending the authentication response signal to the first location from the second location.

### BACKGROUND OF THE INVENTION

The telephone system is a mainstay in commerce, with the commercial uses of the telephone systems ranging from catalog and mail-order merchandising, to the recent and rapid growth in e-commerce taking place via the Internet. A simplified representation of a telephone system is shown in FIG. 1. A user may make a call from a telephone device (10), to be connected by a ring wire (12) and a tip wire (14) to a Central Office (CO) (16) of the telephone system. The wiring between the telephone device (10) and the CO (16) is called a local loop (17). The CO (16) typically powers the local loop (17) with a battery, which causes a current to flow over the local loop (17). The CO (16) connects to the Public Switched Telephone Network (PSTN) (18). A Private Branch Exchange (PBX) (24) interfaces the telephone system with multiple telephone devices in an office building or other large groups of telephone device users.

FIG. 2 shows a telephone device. The telephone device (10) connects to a ring wire (12) and a tip wire (14). The telephone device (10) includes a ringer unit (30), which a CO may cause to ring by sending an appropriate signal. A hook switch (32) connects and disconnects the telephone device to the local loop. The current flowing through the local loop is modulated by audio frequencies generated by a microphone (34) when the user speaks. The modulation of the current carries the words spoken by a user.

A Dial Tone Multi-Frequency (DTMF) decoder (35), which typically has a keypad by which the user may enter numbers, generates audio frequency tones that also modulate the current on the local loop. The tones generated by the DTMF decoder (35) send a signal to the CO. The signal tells the CO what number the user is dialing. Signals from the DTMF decoder (35) may also be used for other purposes. For example, voice-messaging devices may use the DTMF decoder (35) audio frequency output in order to enable a user to interact with a voice mail directory or navigate through a customer service menu. Because the DTMF decoder generates audio frequencies, and because the telephone system is designed to pass audio frequencies, the signals output by the DTMF decoder (35) pass through the telephone system to a device at a destination. There, at the destination, the audio signals may be used by a voice messaging device, or any other appropriate device, in order to accomplish some task, such as leaving a voice mail for someone.

A hybrid speech network (36) manages output from the microphone (34), and input to an earpiece speaker (38). The microphone (34) and earpiece speaker (38) are included as part of the handset (40).

The telephone system is a communications channel, and, as do most communications channels, the telephone system imposes limitations on the characteristics (such as frequency) of signals that are sent on the telephone system. The telephone system is designed to carry analog signals in a frequency range of approximately 200 to 3400 Hertz (HZ). Therefore, in order for a signal to be sent over the telephone system without degradation from a source to a destination, the signal's frequency generally needs to be constrained within the 200-3400 HZ frequency range. However, high frequency digital signals may be sent over the telephone system, if converted to analog signals of appropriate frequency range (i.e., 200 to 3400 HZ), for transmission over a local loop. For example, a first modem converts the digital signal from a computer to an analog signal by modulating the current on the local loop (17 in FIG. 1) with the digital signal. A second modem demodulates the analog signal, and sends the digital signal to another computer. In general, a communications channel may place limitations upon signals that are sent over the communications channel. In order to send a signal from a source to a destination over the communications channel, it may be necessary to alter certain characteristics of the signal in order to ensure that the signal reaches the destination without degradation. The use of a modem is an example of altering characteristics of a signal in order to send the signal over the communications channel, such as a telephone system. For example, bandwidth limitations upon a communications channel, such as a telephone system, may require that data in a signal be compressed.

Telephonic communications has been greatly facilitated by the integration of computer systems and telephone systems. A telephone system may be integrated with a computer system by using Computer Telephony Integration (CTI). CTI allows computer software operating on a computer system to control a telephone system. CTI software is often used to enable operators working in a call center to handle incoming calls. FIG. 3 shows a network architecture of a call center. Incoming calls from a telephone device (10) are routed by a call center server (41) to multiple operator stations (42, 44) using a PBX (24). Each operator station (42, 44) includes a workstation computer (46, 48) and an operator telephone device (50, 52). CTI software running on the call center server (41) is aware of incoming calls, and may, with the aid of a call center network (53), present an appropriate Customer Relationship Management (CRM) display screen on the operator workstations (46, 48). The call center server (41) may also coordinate an Interactive Voice Response (IVR) System, which may be used to collect information from customers on incoming calls. In other call center implementations, a general-purpose computer may substitute for the PBX (24). The general purpose computer may have telephony boards and specialized software that allow the general purpose computer to perform the tasks of a PBX (24), coordinate IVR activities, and route voice streams to operators.

Because of the increased number of transactions, both commercial and otherwise, that are taking place over the telephone system, such as computer networks, authentication of identity is of increasing importance. Authenticating identity using communications channels, such as computer networks and telephone systems, requires the use of authentication signals. An authentication signal is a signal used in authenticating identity of an entity, such as a human being.

One of the most important ideas in authentication and authentication signaling is public key cryptography. The basic concept involved in public key cryptography is a mathematical concept that can be used to relate certain pairs of large numbers (called keys) in a special way. If one of the keys is used to encrypt a message, the other key, and only the other key, may be used to decrypt the message, and vice versa. One key is called a private key and the other is called a public key.

Public Key Infrastructure (PKI) is a collection of components that is used to enhance the security of communications and transactions over computer networks. PKI is increasingly being used for e-commerce, credit card-based transactions, and in other areas, in order to solve the problem of authenticating identity and ensuring that private data is controlled. Central to PKI is the use of digital certificates, which is a type of electronic credentials. Digital certificates facilitate identity authentication by using public key cryptography. In a typical scenario where a digital certificate may be useful, a first party, for example, a merchant may wish to conduct a transaction over a computer network with a second party, a potential customer. The merchant, however, may have doubts regarding the identity of the first party. If the customer has previously arranged to have a digital certificate made publicly available, then the merchant may authenticate the identity of the second party using the digital certificate. Digital certificates are issued by a trusted third party, a Certification Authority (CA). In order to obtain a digital certificate, the customer establishes identity with the CA by providing such documentation to the CA as is needed. Once the customer has satisfactorily proven identity to the CA, the CA creates a digital certificate that is available to the public. The digital certificate includes a public key for the customer. The CA gives a copy of the digital certificate to the customer, which includes the private key. Once the customer has the private key, and the public key is stored in a location accessible to the merchant over a computer network, the transaction between the merchant and the customer may be facilitated with the use of PKI challenge authentication.

For example, if the customer is trying to buy an item via the Internet, from a web site belonging to the merchant, FIG. 4 shows a flow diagram for PKI challenge authentication. Both a transaction and identity authentication take place over the same communications channel (60), in this case, the Internet. The customer is located at the remote computer (62). The remote computer (62) has access to a digital certificate containing a private key (63). For example, the digital certificate containing the private key (63) may be stored on the hard drive of the remote computer (62). When the customer attempts to make a purchase via a web site, a purchase request signal is sent over the communications channel (60) by the remote computer (62) to a local computer (64). The software controlling purchases on the web site needs to authenticate the customer's identity before proceeding with the transaction. Accordingly, the local computer (64) sends a challenge (66) to the remote computer (62), which uses the private key (63) to sign the challenge. The challenge (66) may be some random data generated by the local computer (64). The private key (63) is used to create a digital signature by encrypting the challenge (66). A signed challenge (68) is sent to the local computer (64). The local computer (64) acquires a digital certificate (69) and public key (70) associated with the customer from a PKI server (72). The local computer (64) uses the public key (70) to check that the signed challenge (68) was signed by the private key (63) that matches the public key (70) stored on the PKI server (72). The local computer (64) then sends an authentication response (74) to the remote computer (62) that either affirms or denies the identity of the customer.

The PKI server (72) may use a Lightweight Directory Access Protocol (LDAP)-enabled directory or database in order to support PKI. LDAP is the Internet standard for directory lookups, just as the Simple Mail Transfer Protocol (SMTP) is the Internet standard for delivering e-mail and the Hypertext Transfer Protocol (HTTP) is the Internet standard for delivering documents. Technically, LDAP is defined as an on-the-wire bit protocol (similar to HTTP) that runs over the Transmission Control Protocol/Internet Protocol (TCP/IP). LDAP creates a standard way for software applications to request and manage directory or database information. The LDAP-enabled directory or database becomes a specialized, central repository that contains information about objects and provides access and information to all software applications on the network, such as the software application on the local computer (64) that requested the digital certificate for the customer. Information regarding a variety of objects may be stored in an LDAP-enabled directory. For example, text, photos, links to web pages, binary data, and digital certificates may be stored in an LDAP-enabled directory or database and retrieved for use later.

One popular use of PKI is the area of authenticating identity with the use of security tokens, such as memory sticks, smart cards (also known as Integrated Circuit Cards (ICC)), or other devices of similar functionality. Smart cards are plastic, credit card sized, and tamper-resistant cards that include electronics components that serve as non-volatile memory, a microprocessor, cryptographic components, and a random number generator. A private key may be stored on a security token, e.g., along with other data. Thus, a smart card may be used to encrypt data to create a digital signature for the purpose of identity authentication. Smart cards may be used in many applications, such as commercial transactions or security access applications. Smart cards are used with security token readers, which may read information from a smart card inserted into the security token reader.

In an authentication process where a smart card is used to authenticate identity for a transaction, a customer may walk into a store and attempt to make a purchase. In order to authenticate the customer's identity, the merchant may request the customer to insert the smart card into a security token reader. The security token reader prompts the customer to enter a PIN. The PIN is stored on the smart card by a CA when a certificate and a private key are stored on the smart card. The combination of the customer's possession of the smart card and the customer's knowledge of the PIN is part of a two-factor authentication process. Two-factor authentication lessens the possibility that the smart card may be stolen and used—without the PIN, the card cannot be used.

From this point, the remainder of the authentication process using a smart card proceeds in a similar manner to the previous example shown in FIG. 4. A sequence of events using a smart card for PKI challenge authentication may proceed as follows: an authentication request is initiated by a customer, a challenge is generated, the challenge is signed by a private key on the smart card, and a signed challenge is sent to a local computer. Then, the local computer downloads a digital certificate containing a public key from a PKI server and uses the public key to authenticate the identity of the customer, by authenticating the signed challenge. The local computer authenticates the signed challenge by verifying that the private key that signed the challenge matches the public key obtained from the PKI server. Then, an authentication response (either affirmative or negative) is sent to the security token reader, and the security token reader typically provides some prompt to the waiting merchant indicating whether the customer's identity has been authenticated. The authentication may take place over an appropriate communications channel, such as a computer network for which the security token reader has the appropriate software and communications protocol.

Identity authentication may also involve biometrics. Biometrics involves the use of a uniquely identifying personal characteristic. For example, the pattern of a person's iris, retina, voice, face, or fingerprints may serve to identify the person. A current use of biometrics for identity authentication involves an entrance to secured area where visitors are subjected to some form of scanner or detector that gathers data on some personal characteristic, such as voice patterns. The gathered data for the visitor is compared to a stored version of the gathered data for the visitor. If the gathered data matches the stored version of the gathered data for the visitor, the visitor is admitted to the secured area. Authentication signals associated with biometrics data may also travel over longer distances, such as over Internet connections.

In-band signaling over a telephone system is the exchange of signals on the same communications channel over which a conversation occurs. In-band signaling may occur over the telephone system if allowances are made for the frequency limitations of the telephone system, i.e., a 200 to 3400 HZ limitation imposed by filters or other mechanisms. A common example of in-band signaling is a caller ID feature typical of many telephone systems that uses frequency shift keying (FSK) modulation to send a digital signal using audio frequencies over the telephone system. Using FSK, in a possible implementation of caller ID, a modem at the CO of the calling party sends a signal containing the telephone number of the calling party to a Caller ID equipment box at the location of the receiving party. The Caller ID equipment box then demodulates the FSK modulated audio frequency signal. In order to send the signal, an FSK modem at the CO may, for example, generate a 1200 HZ tone, which represents a “one”, and a 2200 HZ tone, which represents a “zero.” A sequence of ones and zeroes may thereby represent the telephone number of the calling party.

Caller ID signaling may be classified as in-band signaling because there are two distinct communications that occur on the same communications channel. FIG. 5 shows a typical sequence of operations involving caller ID signaling. A first ring signal is sent from a CO associated with the receiving party to the telephone device of the receiving party, which alerts the receiving party that a phone call is incoming (Step 80). Then, the CO associated with the calling party encodes the telephone number of the calling party according to a protocol (Step 81) and sends an encoded caller ID signal to the Caller ID equipment box at the location of the receiving party (Step 82). The caller ID equipment box decodes the encoded caller ID signal (Step 83) and displays the telephone number of the calling party on a display for the receiving party to see (Step 84). Then, the second ring signal is sent from the CO of the receiving party to the telephone device of the receiving party (Step 85). Thus, caller ID signaling reveals the telephone number of the calling party. Caller ID is an example of a type of in-band signaling because two different types of communications are sent over the same communications channel.

### SUMMARY OF INVENTION

In general, in one aspect, the invention relates to a method of authentication signaling on a telephone system. The method comprises preparing an authentication signal to be sent over the telephone system, sending the authentication signal over the telephone system from a first location to a second location, authenticating a user identity using stored authentication information upon receipt of the authentication signal at the second location, creating an authentication response signal to the authentication signal using a result of authenticating the user identity, and sending the authentication response signal to the first location from the second location.

In general, in one aspect, the invention relates to an authentication system for authenticating a user identity over a telephone system. The authentication system comprises a user authentication apparatus operatively connected to the telephone system, configured to collect user data for a user, generate an authentication signal using the user data, and receive an authentication response signal, and a central authenticator apparatus operatively connected to the telephone system, configured to receive the authentication signal and send the authentication response signal to the user authentication apparatus to authenticate the user.

In general, in one aspect, the invention relates to an apparatus for authentication signaling on a telephone system. The apparatus comprises means for preparing an authentication signal to be sent over the telephone system, means for sending the authentication signal over the telephone system from a first location to a second location, means for authenticating a user identity using stored authentication information upon receipt of the authentication signal at the second location, means for creating an authentication response signal to the authentication signal using a result of authenticating the user identity, and means for sending the authentication response signal to the first location from the second location.

Other aspects and advantages of the invention will be apparent from the following description and the appended claims.

### BRIEF DESCRIPTION OF DRAWINGS

FIG. 1 shows a telephone system.

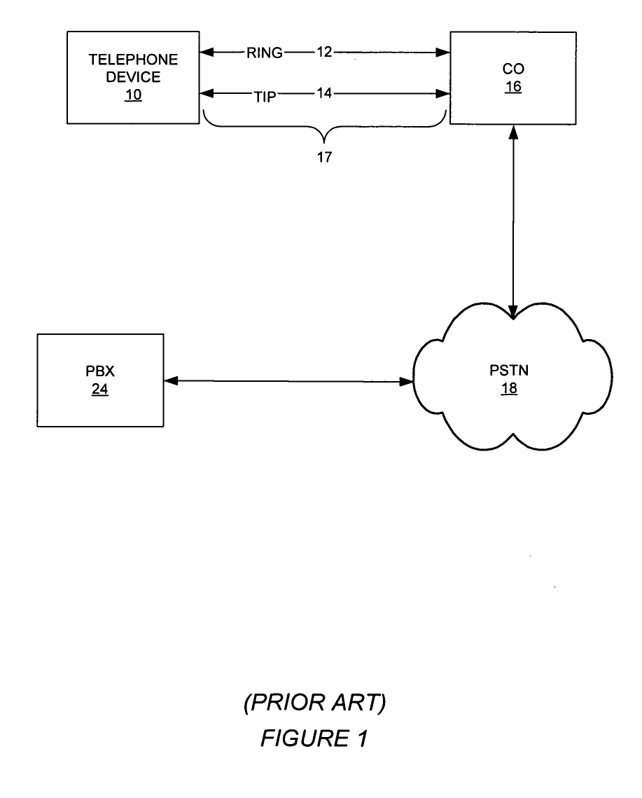

FIG. 2 shows components of a typical telephone device.

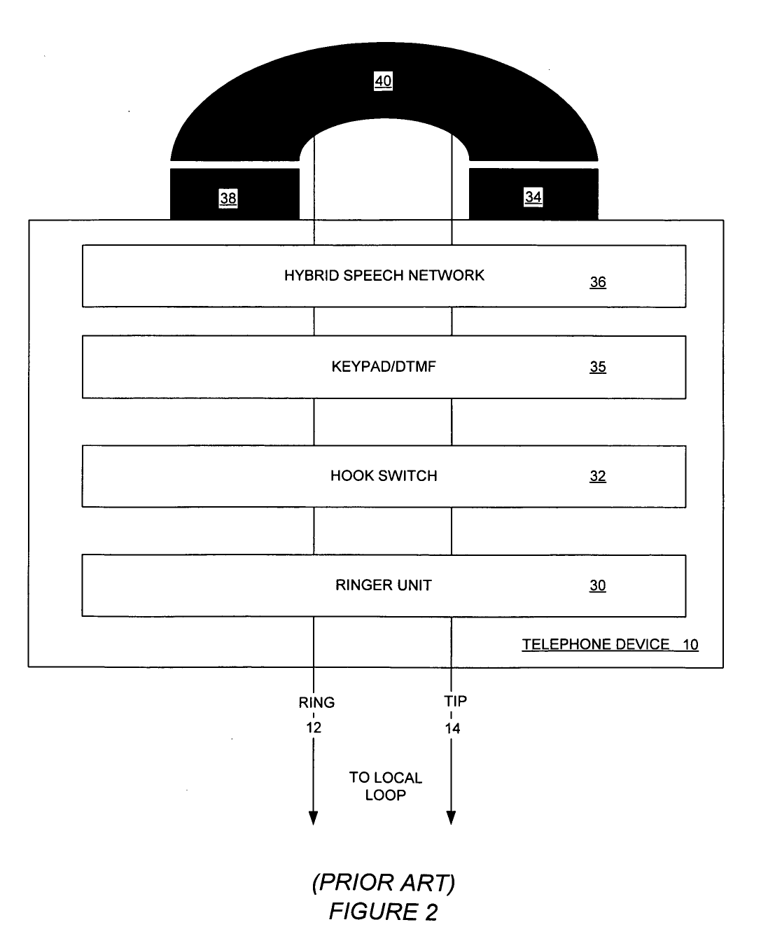

FIG. 3 shows a call center network architecture.

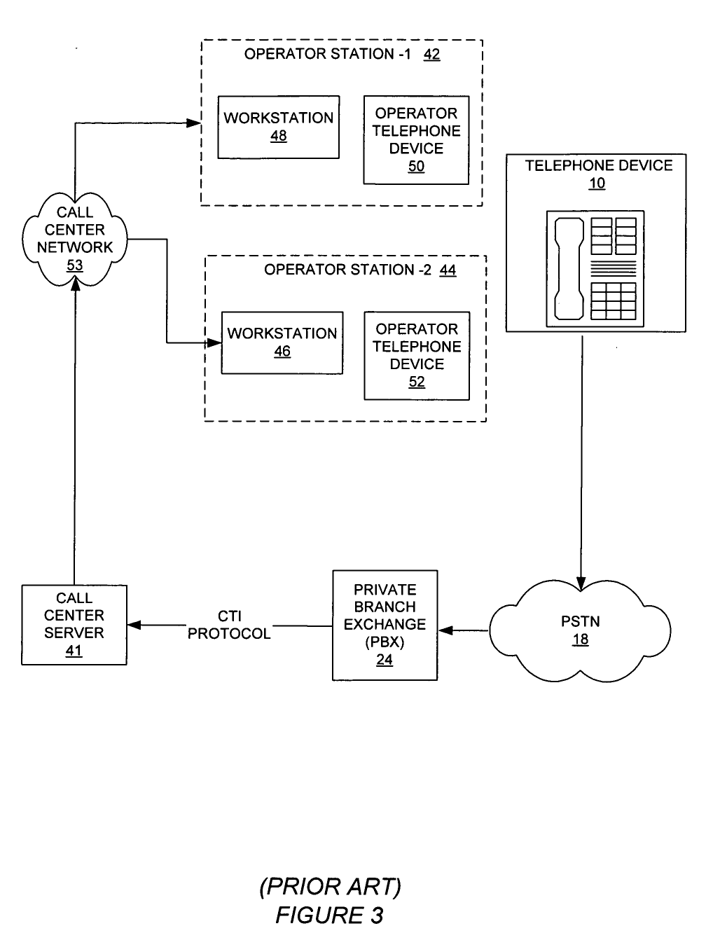

FIG. 4 shows a flow diagram for PKI challenge authentication.

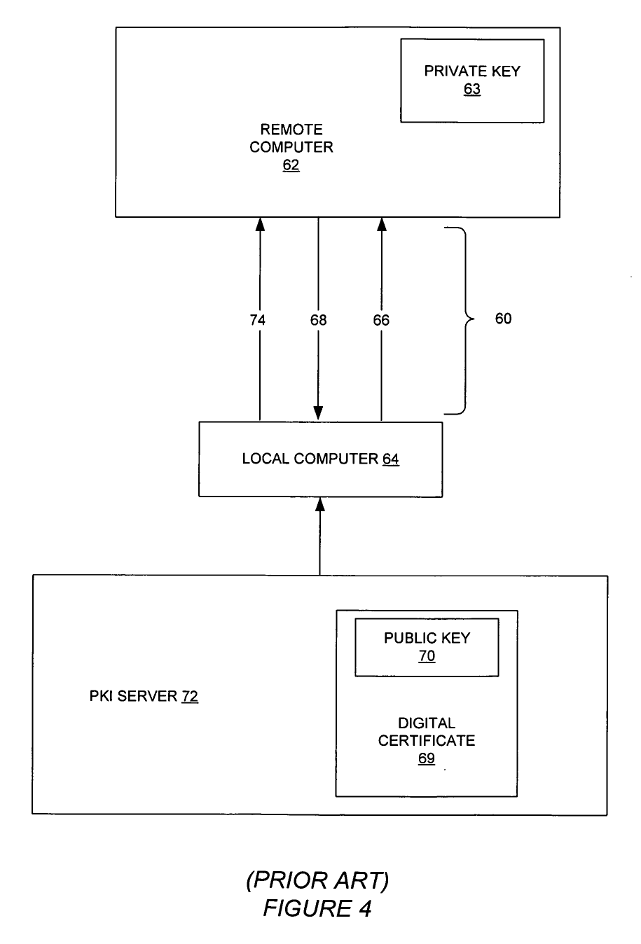

FIG. 5 shows a representation of Caller ID signaling.

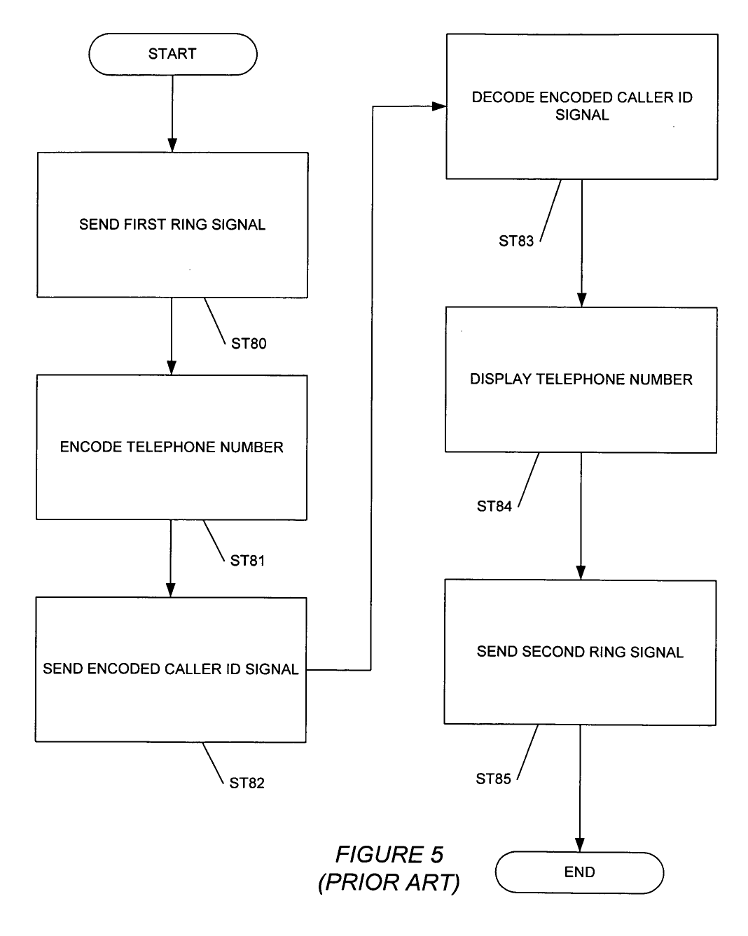

FIG. 6 shows, in accordance with an embodiment of the present invention, a User Authentication Apparatus and a Central Authenticator Apparatus.

FIG. 7 shows, in accordance with an embodiment of the present invention, a Security Token User Authentication Apparatus.

FIG. 8 shows, in accordance with an embodiment of the present invention, a representation of a Security Token User Authentication Apparatus.

FIG. 9 shows, in accordance with an embodiment of the present invention, a stand-alone version of a Security Token User Authentication Apparatus.

FIG. 10 shows, in accordance with an embodiment of the present invention, a Central Authenticator Apparatus.

FIG. 11 shows, in accordance with an embodiment of the present invention, a first flowchart for an in-band authentication process using PKI challenge authentication.

FIG. 12 shows, in accordance with an embodiment of the present invention, a second flowchart for an in-band authentication process using PKI challenge authentication.

FIG. 13 shows, in accordance with an embodiment of the present invention, a third flowchart for an in-band authentication process using PKI challenge authentication.

### DETAILED DESCRIPTION

Specific embodiments of the invention will now be described in detail with reference to the accompanying figures. Like elements in the various figures are denoted by like reference numerals for consistency.

In the following detailed description of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

Although advances in security are prolific in the realm of web-based e-commerce, telephone networks have lagged the web with respect to advances in security and identity authentication. The present invention involves authenticating the identity of an entity, such as a person, over a telephone device using an apparatus and method for in-band identity authentication.

In order to accomplish in-band identity authentication over a telephone system, a User Authentication Apparatus and a Central Authenticator Apparatus is used. The User Authentication Apparatus is at a location of the entity whose identity is to be authenticated. The User Authentication Apparatus collects user data in order to create authentication signals to be sent over the telephone system. The User Authentication Apparatus also uses the user data in the creation of authentication signals that are sent over the telephone system. The authentication signals are in-band authentication signals, in that the authentication signals are sent over the same communications channel as a voice conversation on the telephone device connected to the telephone system. The User Authentication Apparatus interacts with a Central Authenticator Apparatus via authentication signals and authentication response signals in order to accomplish identity authentication of the person and/or entity.

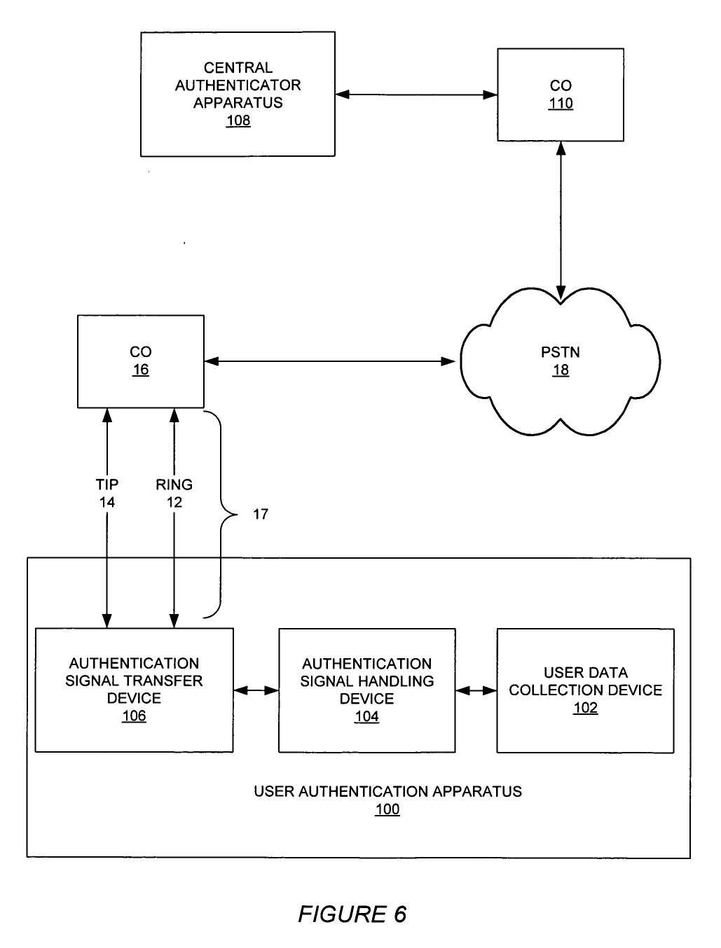

In accordance with an embodiment of the present invention, FIG. 6 shows a User Authentication Apparatus connected to a Central Authenticator Apparatus via a telephone system. The User Authentication Apparatus (100) includes a User Data Collection Device (102), an Authentication Signal Handling Device (104), and an Authentication Signal Transfer Device (106). Other devices, such as switches and power supplies may be included as needed. The User Authentication Apparatus (100) is connected via a ring wire (12) and a tip wire (14) to telephone system components, such as a first CO (16), a PSTN (18), and a second CO (110), through which the User Authentication Apparatus (100) may communicate with a Central Authenticator Apparatus (108). The User Authentication Apparatus (100) communicates with the Central Authenticator Apparatus (108) via in-band authentication signaling to accomplish identity authentication of an entity.

The User Data Collection Device (102) collects data in a variety of ways and forms. For example, the User Data Collection Device (102) may read a private key from a security token and a PIN from a DTMF decoder. The User Data Collection Device (102) may also read from a scanning device, biometrics data such as retinal data or fingerprint data, or other personal identifying characteristics of a person.

The Authentication Signal Handling Device (104) prepares and handles data gathered from the User Data Collection Device (102) and creates and prepares authentication signals in a variety of ways. For example, data and/or signal compression may occur. Also, logic circuitry or software encodes data and/or authentication signals according to a protocol. Authentication signals are created and prepared from collected data in a variety of ways and forms, so that in-band authentication signals may be sent over the telephone system. The Authentication Signal Handling Device (104) also handles authentication response signals received by the Authentication Signal Transfer Device (106).

The Central Authenticator Apparatus (108) is capable of decoding authentication signals and encoding authentication response signals using the same protocol(s) used by the User Authentication Apparatus. In accordance with an embodiment of the present invention, authentication signaling strategies may include PKI challenge authentication or authentication of biometrics data.

One skilled in the art will appreciate that the arrangement and number of components and devices as shown in FIG. 6 may vary in accordance with an embodiment of the present invention. For example, data and/or signal compression may also occur in the Authentication Signal Transfer Device (106). A PBX may be included in the telephone system.

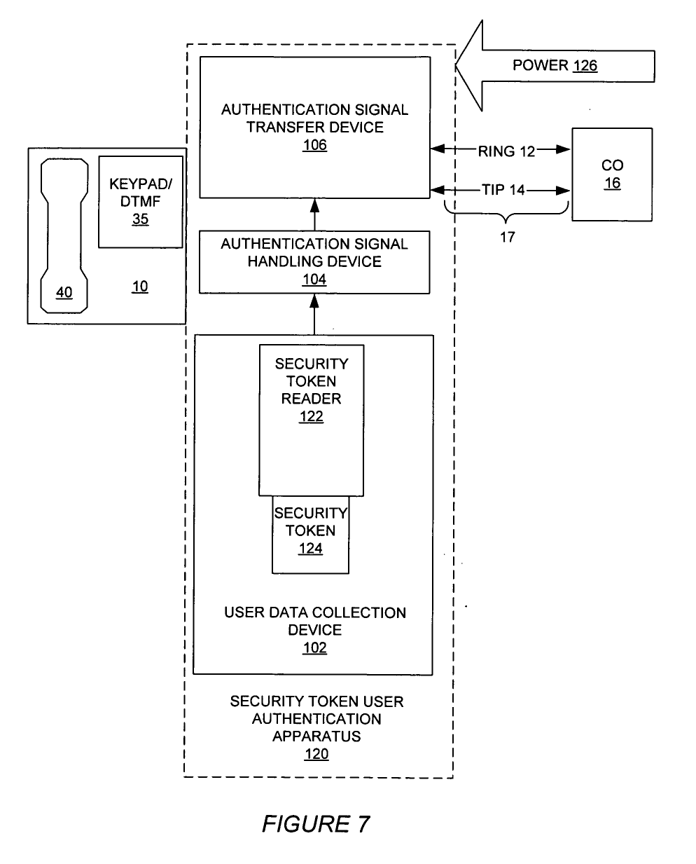

In accordance with an embodiment of the present invention, in-band authentication using a telephone system may involve different embodiments of a User Authentication Apparatus. As shown in FIG. 7, a Security Token User Authentication Apparatus (120), in accordance with an embodiment of the present invention, is integrated into a telephone device (10), which is attached via a ring wire (12) and a tip wire (14) to a local loop (17) and a CO (16). The Security Token User Authentication Apparatus (120) includes a User Data Collection Device (102), an Authentication Signal Handling Device (104), and an Authentication Signal Transfer Device (106). The User Data Collection Device (102) includes a security token reader (122), and a security token (124) is shown inserted into the security token reader (122). In this embodiment, the security token reader (122) is designed in a manner consistent with the Personal Computer/Smart Card Standard (Interoperability Specification for ICC's and Personal Computer Systems Part 2, Interface Requirements for Compatible IC cards and Readers). The security token (124) is compliant with ISO 7816-4 Information Technology—Identification cards-integrated circuit(s) cards with contacts—Part 4: Inter-industry commands for interchange. A DTMF decoder (35) (with a keypad) enables a user, such as a customer engaged in a transaction, to enter a PIN associated with the security token (124). A conversation with a customer service representative or an operator in order to conduct the transaction may take place using a handset (40). Electrical power (126) is supplied as an input.

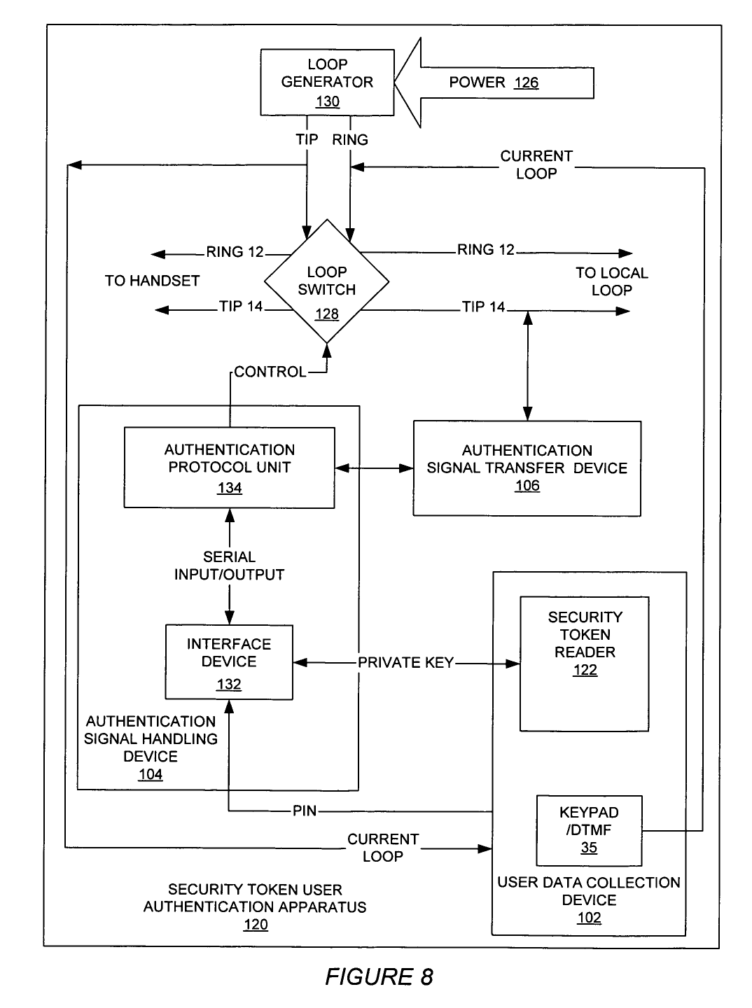

The Security Token User Authentication Apparatus (120), in one embodiment of the present invention, is shown in more detail in FIG. 8. The Security Token User Authentication Apparatus (120) includes the User Data Collection Device (102), the Authentication Signal Handling Device (104), the Authentication Signal Transfer Device (106), a loop switch (128), a loop generator (130), the electrical power input (126), and other interconnecting wiring and other circuitry as needed (not shown). The User Data Collection Device (102) includes the security token reader (122) and the DTMF decoder (35) (with keypad) to input a PIN.

The Authentication Signal Handling Device (104) includes an interface device (132) to read a PIN from the security token reader (122). The interface device (132) also takes input from the DTMF decoder (35). The DTMF decoder (35) is supplied direct current from the loop generator (130), which the DTMF decoder (35) uses to create audio frequency tones. The loop switch (128) directs signal and direct current as needed. The loop switch (128) may be used to isolate the handset from the Security Token User Authentication Apparatus (120) while a PIN is being entered into the DTMF decoder (35). The loop switch (128) is controlled by an Authentication Protocol Unit (134), which is included in the Authentication Signal Handling Device (104).

The Authentication Protocol Unit (134) includes authentication logic circuits, which create encoded authentication signals to be sent to the Authentication Signal Transfer Device (106). The Authentication Protocol Unit (134) also decodes authentication signals from the Authentication Signal Transfer Device (106). The encoding and decoding of authentication signals is facilitated by an authentication protocol, which the authentication logic circuits are capable of executing. The Authentication Protocol Unit (134) takes input from the interface device (132).

The Authentication Signal Transfer Device (106) sends authentication signals over the telephone system through the ring wire (12) and the tip wire (14). The Authentication Signal Transfer Device (106) may be a modem that uses a modulation technique similar to that used in Caller ID signaling. One skilled in the art will appreciate that other modulation techniques may be used. The output of the Authentication Signal Transfer Device (106) is within a frequency range that is passed by a telephone system, i.e., 200-3400 HZ. The characteristics of the authentication signals output by the Authentication Signal Transfer Device (106) and Security Token User Authentication Apparatus (120) conform to a particular telephone system environment in order to send authentication signals successfully. For example, a Security Token User Authentication Apparatus (120) may be used in conjunction with a cellular telephone device that uses a vocoder, which may require alteration of the authentication signals in order to pass the authentication signals through the vocoder.

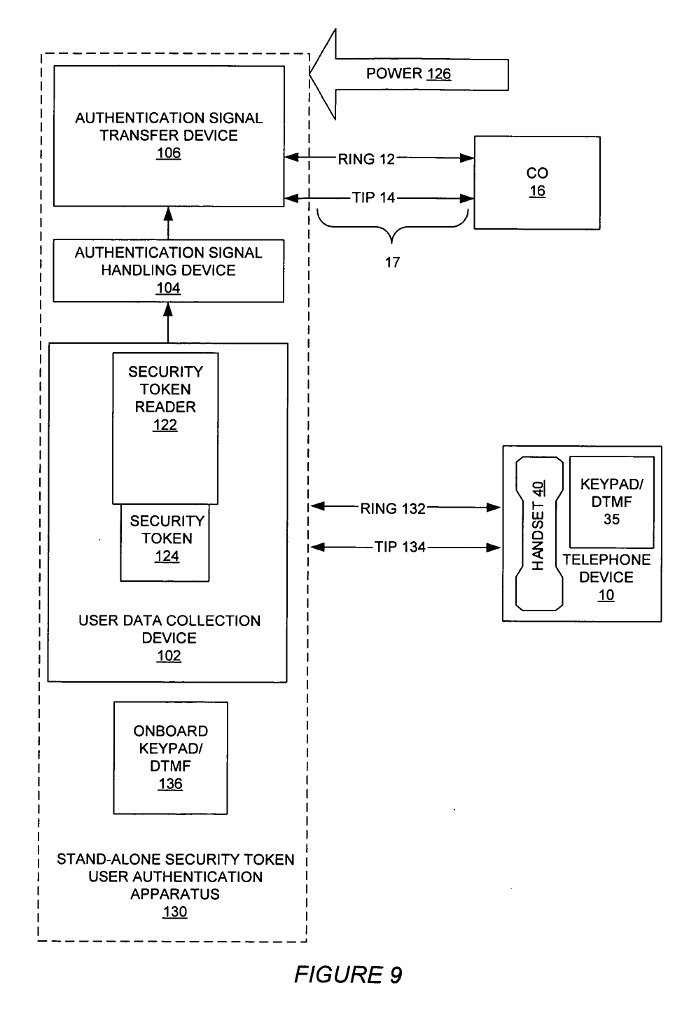

Instead of being integrated with a telephone device, as shown in FIG. 7, one embodiment of a Security Token User Authentication Apparatus operates as a stand-alone unit. In accordance with an embodiment of the present invention, FIG. 9 shows a stand-alone Security Token User Authentication Apparatus (130) connected to the telephone device (10) via an input ring wire (132) and an input tip wire (134) and connected to the local loop (17) and the CO (16). The stand-alone Security Token User Authentication Apparatus (130) includes the User Data Collection Device (102), the Authentication Signal Handling Device (104), and the Authentication Signal Transfer Device (106). The User Data Collection Device (102) includes the security token reader (122), and the security token (124) is shown inserted into the security token reader (122). In this embodiment, the security token reader (122) is designed in a manner consistent with the Personal Computer/Smart Card Standard (Interoperability Specification for ICC's and Personal Computer Systems Part 2, Interface Requirements for Compatible IC cards and Readers). The security token (124) is compliant with ISO 7816-4 Information Technology—Identification cards-integrated circuit(s) cards with contacts—Part 4: Inter-industry commands for interchange. An onboard DTMF decoder (136) enables a user, such as a customer engaged in a transaction, to enter a PIN associated with the security token (124). A conversation with a customer service representative or an operator in order to conduct the transaction may take place using a handset (40). Electrical power (126) is supplied.

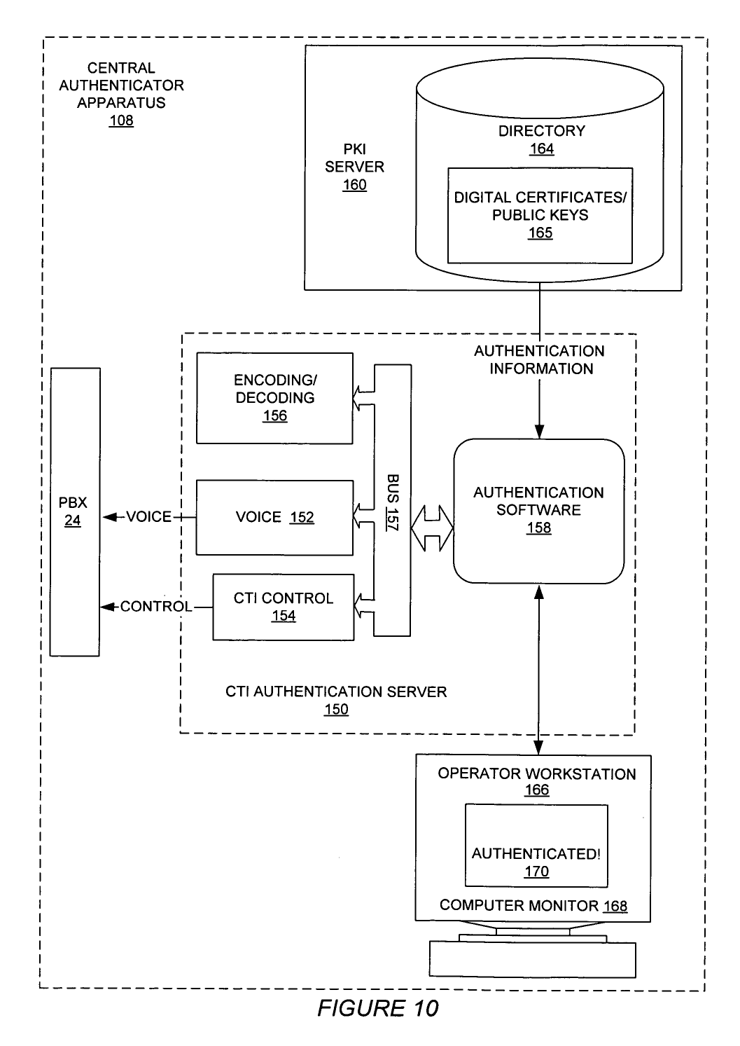

In accordance with an embodiment of the present invention, a Central Authenticator Apparatus (108) is shown in FIG. 10. The Central Authenticator Apparatus (108) is associated with a call center in order to perform identity authentication using PKI challenge authentication. The Central Authenticator Apparatus (108) shown in FIG. 10 works in conjunction with the Security Token User Authentication Apparatus. A CTI authentication server (150) performs challenge generation and signature authentication in conjunction with other entities as may be needed in order to implement in-band authentication. The CTI authentication server (150) uses the same authentication protocol to encode and decode signals that the authentication protocol unit uses. In accordance with an embodiment of the invention, the CTI authentication server (150) also modulates and encodes authentication response signals and sends the authentication response signals over a telephone system to the Security Token User Authentication Apparatus. The CTI authentication server (150) interfaces with a PBX (24) through one or more voice modules (152), which manage voice streams. The voice module (152) is typically computer hardware, such as line cards. A CTI control module (154) is used to control telephone calls. Typically, the CTI control module (154) is computer hardware, such as a card that connects to a bus in the computer on which the CTI authentication server (150) is running. An encoding/decoding module (156) is used to encode and decode authentication signals sent from and to the Security Token User Authentication Apparatus. In one embodiment, the encoding/decoding module (156) may be a Digital Signal Processing (DSP) card. A bus (157), such as a PCM bus, interfaces authentication software (158) with the encoding/decoding module (156), the voice module (152) and the CTI control module (154). The authentication software (158) manages authentication signals and interfaces with other entities as needed, such as a PKI server (160). The PKI server (160) includes an LDAP-enabled directory (164) containing PKI public keys and/or digital certificates (165). The CTI authentication server (150) acquires authentication information, such as a public key and/or digital certificate from the PKI server (160). The CTI authentication server (150) also interfaces with an operator workstation (166) using an operator console communication. An operator at the operator workstation (166) can start an authentication process by using software that interfaces the operator workstation (166) with the CTI authentication server (150). The authentication process may be managed, in part, by the authentication software (158) so that certain tasks may be automated. For example, the authentication process may be automated to a degree that operators may be required only to press a single key in order to complete authentication, or operators may receive only pre-authenticated calls. An authentication process result is presented on a suitable display device, such as a computer monitor (168). The authentication process result may be in the form of a window (170) displaying an outcome of the authentication process, e.g., the phrase “Authenticated!” for an affirmative outcome may be displayed. Authentication response signals sent from the Central Authenticator Apparatus to the Security Token User Authentication Apparatus are in-band signals.

Those skilled in the art will appreciate that the apparatus as shown in FIG. 10 may differ in accordance with an embodiment of the present invention. For example, using different hardware configurations enables the Central Authenticator Apparatus to use a general-purpose computer and associated hardware, such as a T1/E1 card, as a PBX.

Authentication response signals sent over a telephone system by the CTI authentication server (150) may use a modulation technique similar to that used in Caller ID signaling. The authentication signals are in a frequency range suitable for a typical telephone system, i.e., 200-3400 HZ. Other modulation techniques may also be used as needed in order to achieve suitable authentication signaling.

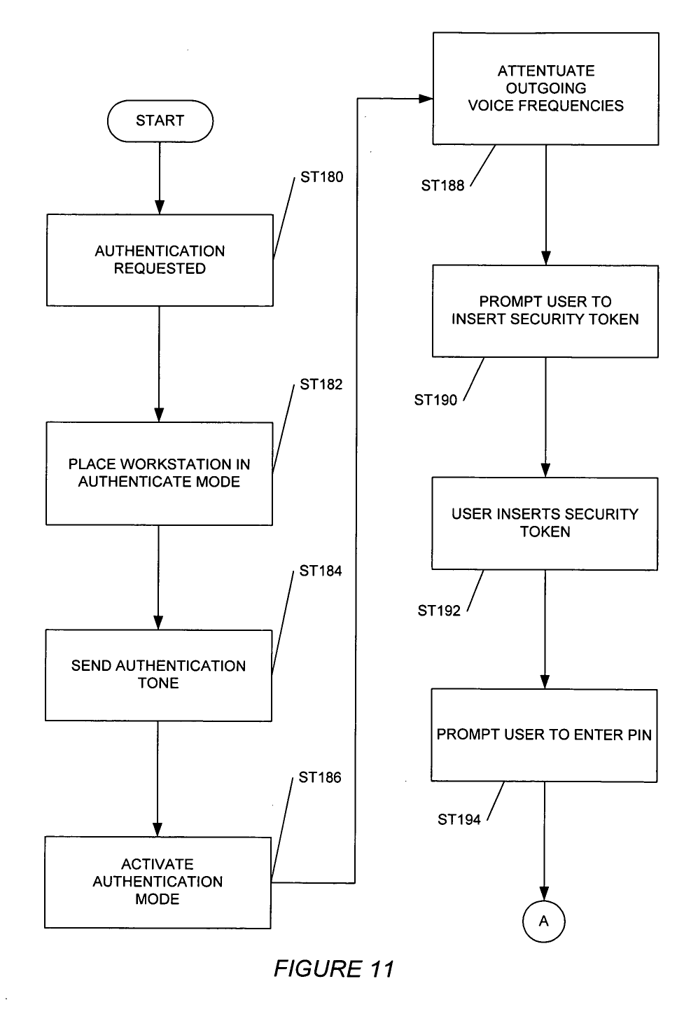

In accordance with an embodiment of the present invention, FIG. 11 shows a flowchart for in-band authentication process using PKI challenge authentication. To begin, a user using the Security Token User Authentication Apparatus requests authentication from a call center (Step 180). The request for authentication is made by voice over the telephone device. In response to the request, an operator using the workstation, places the workstation in authenticate mode (Step 182). The Central Authenticator Apparatus sends an authentication tone to the Security Token User Authentication Apparatus (Step 184). The authentication tone is an audio tone or combination of tones to alert the Security Token User Authentication Apparatus that an authentication process has begun. For example, a particular, unusual combination of tones (such as an “A*” combination) may be sent from the Central Authenticator Apparatus to the Security Token User Authentication Apparatus, which is listening for the unusual tone combination (such as “A*”).

Next, the Security Token User Authentication Apparatus activates authentication mode (Step 186), whereupon the Security Token User Authentication Apparatus attenuates voice frequencies on a ring wire and tip wire (Step 188). The Security Token User Authentication Apparatus prompts the user to insert a security token into a security token reader (Step 190), which may be accomplished with a flashing light, a voice prompt, an LED screen display, or any other appropriate mechanism. The user inserts the security token into the security token reader (Step 192), and the Security Token User Authentication Apparatus prompts the user to enter a PIN number associated with the security token (Step 194).

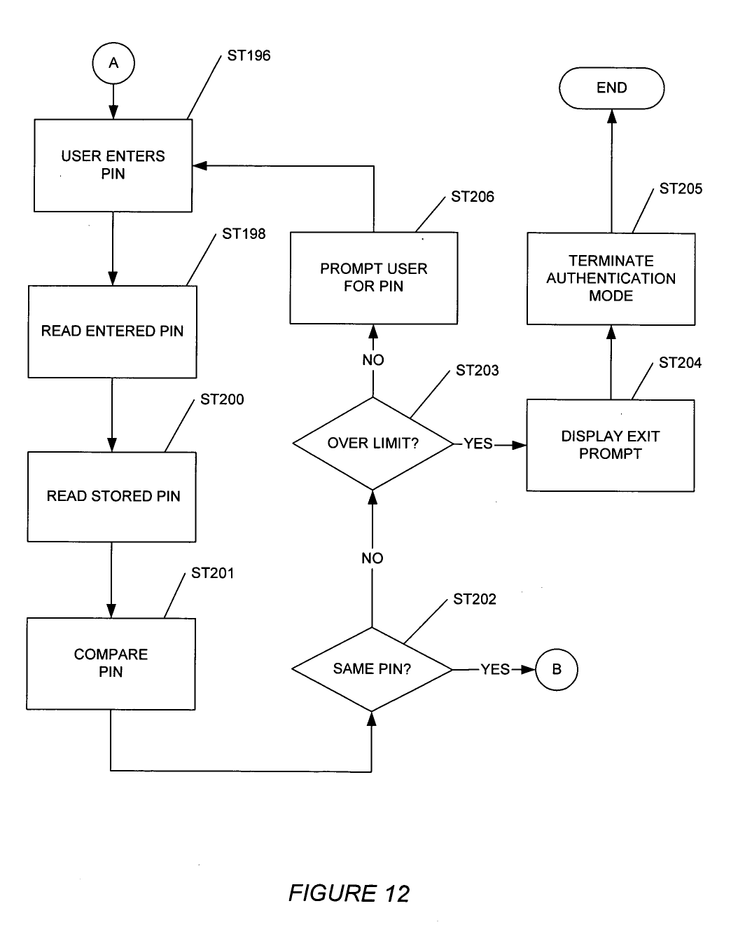

As shown in FIG. 12, the user uses the keypad to enter the PIN into the DTMF decoder (Step 196), and the Security Token User Authentication Apparatus reads the PIN entered by the user (Step 198). Next, the Security Token User Authentication Apparatus reads a stored PIN from the security token (Step 200), compares the PIN entered by the user with the stored PIN (Step 201), and determines whether the entered PIN is valid (Step 202). If the PIN entered by the user is not the same as the stored PIN, the Security Token User Authentication Apparatus determines whether a limit for the number of times the PIN has been entered for the current transaction is greater than a predetermined limit (Step 203). For example, a limit of three times to enter the correct PIN may be predetermined. If the PIN limit has been reached, an exit prompt will be displayed by the Security Token User Authentication Apparatus, telling the user that the limit has been reached (Step 204).

Next, authentication mode will be terminated by sending a termination signal to the Central Authenticator Apparatus, and the transaction ends (Step 205). If the PIN limit has not been reached, the Security Token User Authentication Apparatus prompts the user for a PIN (Step 206).

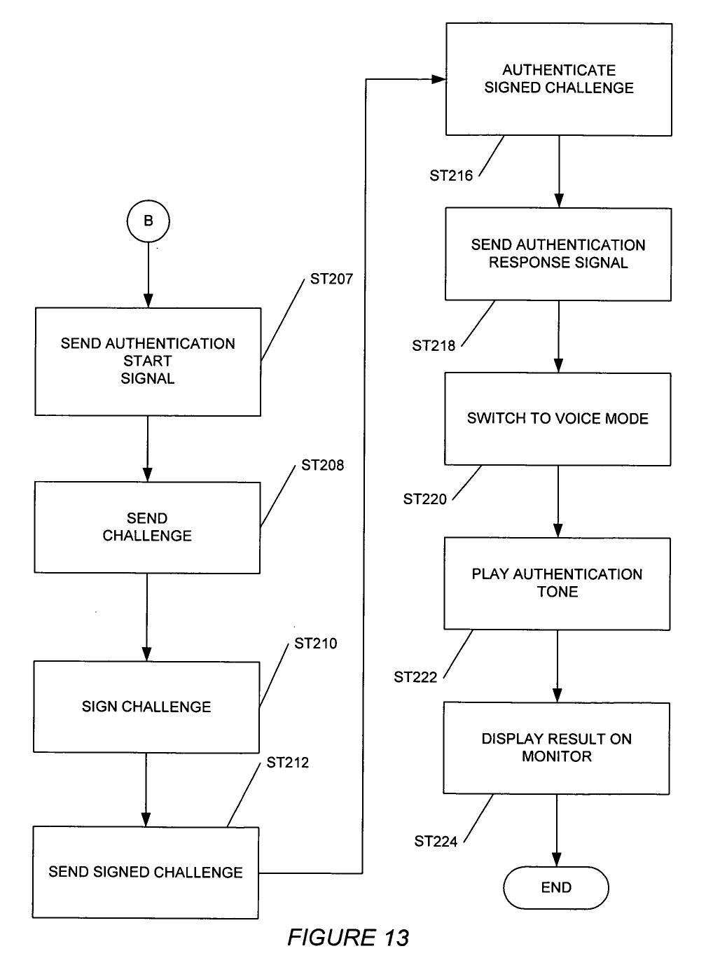

Referring to FIG. 13, if the PIN entered by the user is the same as the stored PIN, the Security Token User Authentication Apparatus sends an authentication start signal to the Central Authenticator Apparatus at the call center (Step 207). The authentication start signal may be a special tone for which the CTI authentication server is waiting. Next, the Central Authenticator Apparatus sends a challenge to the Security Token User Authentication Apparatus. (Step 208). In response to the challenge, the Security Token User Authentication Apparatus creates a signed challenge using public key encryption to sign the challenge (Step 210) and sends the signed challenge to the Central Authenticator Apparatus (Step 212). The Security Token User Authentication Apparatus encodes the challenge using a protocol understood by the CTI authentication server at the call center. The Central Authenticator Apparatus authenticates the signed challenge using stored authentication information, e.g., PKI challenge authentication techniques (Step 216) and sends an authentication response signal to the Security Token User Authentication Apparatus (Step 218). The authentication response signal may be affirmative or negative depending on whether the identity of the user is authenticated. Upon detection of the authentication response signal, the Security Token User Authentication Apparatus switches from authentication mode to voice mode (Step 220). The operator and the user may then continue the transaction by voice. Next, an authentication tone is played on an earpiece speaker indicating that authentication has been affirmed (or denied, as the case may be) (Step 222), and an appropriate authentication result is displayed on an output device, such as a computer monitor of a workstation (Step 224).

Advantages of the present invention include one or more of the following. The invention enables in-band identity authentication over a single channel of communications, thereby lowering equipment and software costs, e.g., a computer and/or Internet connection is not necessarily required. The invention enables in-band authentication for biometrics identity authentication, thereby saving money by avoiding the necessity for constructing or leasing separate lines for telephone devices and authentication. The invention enables secure PIN entry, thereby facilitating the securing of private information. The invention enables two-factor authentication, thereby enhancing the strength of authentication. The invention enables strong, two-factor authentication over a telephone device connected to a telephone system, while also using in-band authentication signaling, thereby enhancing the ratio of authentication strength to equipment expenditure. The invention enables two-factor authentication over a telephone device connected to a telephone system, while also using in-band authentication signaling, thereby enhancing convenience, strength of authentication, and ease of use. The invention increases the number of available sites from which reliable identity authentication can occur and increases the value and attractiveness of a credit card that works in conjunction with the invention. The invention enables the occurrence of a transaction without the speaking of private information aloud, such that the private information may be overheard.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method of authentication signaling on a telephone system, comprising:
preparing an authentication signal to be sent over the telephone system;
sending the authentication signal over the telephone system from a first location to a second location;
authenticating a user identity using stored authentication information upon receipt of the authentication signal at the second location;
creating an authentication response signal to the authentication signal using a result of authenticating the user identity; and
sending the authentication response signal to the first location from the second location.

2. The method of claim 1, wherein the authentication signal is prepared using at least one selected from a group consisting of public key cryptography, biometrics information, encryption, compression, or modulation.

3. The method of claim 1, wherein the authentication response signal is prepared using at least one selected from a group consisting of public key cryptography, encryption, compression, or modulation.

4. The method of claim 1, wherein the authentication response signal is sent at an in-band frequency.

5. The method of claim 1, wherein the authentication signal is sent at an in-band frequency.

6. The method of claim 1, wherein the stored authentication information is accessed from a public key infrastructure server.

7. The method of claim 1, wherein authenticating the user identity comprises reading a PIN for the user identity with a DTMF.

8. The method of claim 1, further comprising:
initiating a transaction to authenticate the user identity;
gathering user data for the user identity;
creating the authentication signal using the user data; and
verifying an outcome of the transaction using the authentication response signal received at the first location.

9. The method of claim 8, wherein gathering the user data comprises using a security token reader.

10. The method of claim 9, wherein the security token reader reads a smart card.

11. An authentication system authenticating a user identity over a telephone system, comprising:
a user authentication apparatus operatively connected to the telephone system, configured to collect user data for a user, generate an authentication signal using the user data, and receive an authentication response signal; and
a central authenticator apparatus operatively connected to the telephone system, configured to receive the authentication signal and send the authentication response signal to the user authentication apparatus to authenticate the user.

12. The authentication system of claim 11, wherein the user authentication apparatus comprises:
an authentication signal handling device;
an authentication signal transfer device; and
a user data collection device.

13. The authentication system of claim 12, wherein the user data collection device comprises a DTMF decoder configured to collect a PIN from the user.

14. The authentication system of claim 12, wherein the central authenticator apparatus is operatively connected to a public key infrastructure server.

15. The authentication system of claim 12, wherein the central apparatus comprises a call center.

16. The authentication system of claim 12, wherein the user authentication apparatus is stand-alone.

17. The authentication system of claim 12, wherein the user data collection device comprises a security token reader.

18. The method of claim 17, wherein the security token reader reads a smart card.

19. The authentication system of claim 12, wherein the authentication response signal comprises an in-band frequency.

20. The authentication system of claim 12, wherein the authentication signal comprises an in-band frequency.

21. An apparatus for authentication signaling on a telephone system, comprising:
means for preparing an authentication signal to be sent over the telephone system;
means for sending the authentication signal over the telephone system from a first location to a second location;
means for authenticating a user identity using stored authentication information upon receipt of the authentication signal at the second location;
means for creating an authentication response signal to the authentication signal using a result of authenticating the user identity; and
means for sending the authentication response signal to the first location from the second location.

22. The apparatus of claim 21, further comprising:
means for initiating a transaction to authenticate the user identity;
means for gathering user data for the user identity;
means for creating the authentication signal using the user data; and
means for verifying an outcome of the transaction using the authentication response signal received at the first location.

23. The apparatus of claim 21, wherein the authentication response signal is sent at an in-band frequency.

24. The apparatus of claim 21, wherein the authentication signal is sent at an in-band frequency.
